(19) United States
(12) Patent Application Publication
(10) Pub. No.: US 2005/0064078 A1
(43) Pub. Date: Mar. 24, 2005

(54) Incorporation of phytosterols into flavorings

(75) Inventors: Albert Anthony Nasser, West Chester, OH (US); Ruth Yong, Park Hills, KY (US); Lauren Hammerschmidt, Morrow, OH (US); William Startup, Cincinnati, OH (US); H. Clint Fairow, Tolono, IL (US); Mary Bishop, Cincinnati, OH (US)

Correspondence Address: MICHAEL BEST & FRIEDRICH, LLP, 100 E WISCONSIN AVENUE, MILWAUKEE, WI, 53202, US

(73) Assignee: Degussa Health & Nutrition Americas, Inc., Cleveland, OH (US)

(21) Appl. No.: 10/939,529

(22) Filed: Sep. 13, 2004

Related U.S. Application Data
(60) Provisional application No. 60/504,857, filed on Sep. 22, 2003.

(51) Int. Cl. A23L 1/22

(52) U.S. Cl. 426/534

(57) ABSTRACT

A method is provided for incorporating phytosterols into foods including steps of blending at least one phytosterol with at least one flavoring to provide an enhanced flavoring and adding the enhanced flavoring to a food to provide an enhanced food. Also provided is an enhanced flavoring composition comprising at least one phytosterol and at least one flavoring.

### CROSS-REFERENCE TO RELATED APPLICATIONS

This application is based upon and claims benefit of priority from prior U.S. provisional application Ser. No. 60/504,857, filed Sep. 22, 2003, the entire contents of which are incorporated herein by reference.

### BACKGROUND

Plant sterols, plant sterol esters, plant sterol glycosides and plant stanols are collectively known as phytosterols. Chemically, these compounds are structurally similar to cholesterol. However, unlike animal-derived cholesterol, which, when ingested, absorbs easily and raises serum cholesterol levels, phytosterols may be difficult to absorb and are therefore only minimally retained by the body.

Phytosterols are classified as 4-desmethylsterols of the cholestane series. Beta-sitosterol, the most abundant phytosterol, has the following chemical structure:

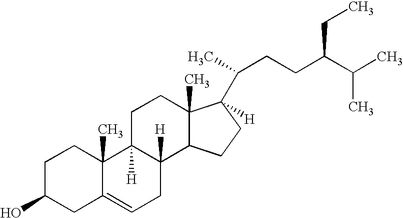

The cylclopentanoper-hydrophenanthrene ring structure of the sterol molecule is common to all sterols; the differences are primarily in the structure of the side chains. Over 200 types of phytosterols have been reported, but beta-sitosterol is the most abundant, comprising about 50% of dietary phytosterols. The next most abundant phytosterols are campesterol (about 33%) and stigmasterol (about 2 to 5%). Other phytosterols include brassicasterol, delta-7-stigmasterol and delta-7-avenasterol.

The mechanism of the cholesterol-lowering activity of phytosterols is not fully understood. Phytosterols appear to inhibit the absorption of dietary cholesterol and the reabsorption (via the enterohepatic circulation) of endogenous cholesterol from the gastrointestinal tract. Another proposed mechanism is the possible inhibition of the rate of cholesterol esterification in the intestinal mucosa. The result is that both phytosterols and dietary cholesterol end up excreted in waste matter.

The United States Food and Drug Administration (FDA) has recently recognized scientific evidence, demonstrating that including phytosterols in the diet helps to lower blood total and LDL cholesterol levels, and that diets including phytosterols may reduce the risk of coronary heart disease. Accordingly, regulations setting forth specific requirements for health claims on food labels have been implemented. In response, food manufacturers have sought economic and efficient means to incorporate phytosterols into food products, in a manner that also does not negatively affect texture or other organoleptic properties.

### SUMMARY OF THE INVENTION

The present invention may include methods which can be used to incorporate phytosterols into a food, such that health claims may be made about the food. The invention also includes unique phytosterol-enhanced flavorings.

In one aspect, the invention may provide a method of incorporating phytosterols into food including steps of adding at least one phytosterol to at least one flavoring to provide an enhanced flavoring and adding the enhanced flavoring to a food to provide an enhanced food.

In another aspect, the invention may provide an enhanced flavoring composition comprising at least one phytosterol and at least one flavoring.

### DESCRIPTION OF SEVERAL EMBODIMENTS OF THE INVENTION

As used herein, “phytosterols” include, but are not limited to, saturated and unsaturated sterol alcohols, their esters and their blends derived from plants (i.e. plant sterols), as well as synthetically produced sterol alcohols, their esters and their blends having properties that replicate those of naturally occurring sterol alcohols and esters. This may include hydrogenated forms of these compounds, whether used in the free sterol form or esterified with fatty acids. The sterol alcohols may be characterized by a common polycyclic steroid nucleus comprising a 17 carbon ring system, a side chain and a hydroxyl group. The nucleus may either be saturated, wherein the sterol alcohol and/or ester is referred to as a stanol, or be unsaturated, wherein the sterol alcohol and/or ester is referred to as a sterol. As used herein, phytosterols may comprise a single sterol, blends of sterols, a single stanol, a blend of stanols or a combination thereof. More particularly, phytosterols may comprise, e.g., alpha-sitosterol, beta-sitosterol, ergosterol, stigmasterol, campesterol, brassicasterol, taraxasterol, clionastanol, 22,23-dihydrobrassicasterol, alpha-sitostanol, beta-sitostanol, stigmastanol, campestanol, 24 beta-methyl cholestanol, or any combination thereof. As will be appreciated, other types of phytosterols may be suitable for use in the present invention.

In one embodiment, the phytosterol may comprise at least 80% sitosterol, campesterol, stigmasterol, sitostanol, campestanol and combinations thereof.

One specific phytosterol blend is commercially available as CHOLESTATIN® (Degussa Bioactives, Waukesha, Wis.). CHOLESTATIN® is a naturally occurring phytosterol complex derived from vegetable oil distillates, including primarily soybean oil. CHOLESTATIN® comprises, by weight, at least about 40.0% beta-sitosterol, at least about 20.0% campesterol, at least about 11.0% stigmasterol, and at least about 0.3% brassicasterol. The total sterol amount in the final blend is greater than about 85.0%. CHOLESTATIN® may also comprise up to 0.1 % ash, and have a bulk density of approximately 0.6 grams per mL. Another commercially available phytosterol blend is COROWISE® (Cargill, Minneapolis, Minn.), which comprises, by weight, at least about 40-58% sitosterol, 20-28% campesterol and 14-23% stigmasterol. COROWISE® has a phytosterol content of at least 88% by weight.

According to FDA regulations, and as used herein, “health claims” regarding phytosterols require that such claims specify the daily dietary intake of plant sterol or stanol esters that is necessary to reduce the risk of coronary heart disease and the contribution one serving of the product makes to the specified daily intake level. As specified in 21 CFR 101.83, which is incorporated herein by reference in its entirety, in general, the daily dietary intake levels of phytosterols that have been associated with reduced risk of coronary heart disease are 1.3 grams or more per day of plant sterol esters and 3.4 grams or more per day of plant stanol esters. Evidence also shows that the lowest effective daily intake of free phytosterols is at least about 800 mg per day.

In accordance with the invention, phytosterols are added to a flavoring. “Adding” or “added,” as used herein, refers to any method that can be used to incorporate one substance into another substance. Typical methods of adding phytosterols to a flavoring include conventional blending and mixing methods. Such methods include, but are not limited to ribbon blending, using a conventional blender, extrusion, tumble blending and using a v-blender. Other suitable methods of adding phytosterols to flavorings include dispersing the phytosterols in oil soluble flavors and emulsifying the phytosterols in flavor emulsions. Adding steps may appropriately be accomplished at room temperature, or ambient temperature, cooler than room temperature or warmer than room temperature.

As used herein, “flavor” or “flavoring” may be used to refer to natural flavors, natural flavors with other natural flavors (“natural WONF”), natural type flavors, artificial flavors, certified organic flavors and organic compatible flavors or combinations of these. “Flavoring,” as used herein, expressly excludes “seasonings,” as the term is used in the art. “Seasonings,” in contrast to “flavorings,” are considered to be a mixture of spices, herbs, taste components (i.e. salt and salt replacements) and colors for use in augmenting the flavor impression of a food. As described in 21 CFR 101.22, the entire contents of which is incorporated by reference herein, the term “spice” means “any aromatic vegetable substance, in the whole, broken, or ground form . . . whose significant function in food is seasoning rather than nutrition. Thus, no portion of any volatile oil or other flavoring. principle has been removed from a true spice. The term “spice flavoring,” in contrast, requires the derivation of the flavor constituent from one or more spices.

As used herein, “artificial flavor” or “artificial flavoring” means any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof. Artificial flavors may also be known in the art as “natural-type flavors,” particularly in Europe.

As used herein, “natural flavor” or “natural flavoring” means the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. Natural flavors may also include other natural flavorings, in which case they are known as “natural flavors WONF (with other natural flavors).”

As used herein, “organic flavors” or organic flavoring” means at least 95% of the ingredients are organic, wherein “organic” means derived naturally from living or once living matter.

Flavors that may be used in the present invention include, but are not limited to, common flavors such as vanilla, chocolate, butter, cheese, spice flavors and combinations thereof. Fruit flavors for use in the invention include, but are not limited to, strawberry, raspberry, blueberry, orange, lemon, apple, grape, lemon-lime, lime, watermelon, coconut flavors and combinations thereof. Process/meat flavors for use in the invention include, but are not limited to, beef, bacon, chicken, pork, seafood flavors and combinations thereof. Spice flavors for use in the invention include, but are not limited to, onion, garlic, pepper, ranch, nacho, taco flavors and combinations thereof. Enzyme-modified dairy flavors for use in the invention include, but are not limited to, cheddar, romano, parmesan, cream, buttermilk, blue cheese, herbal flavors and combinations thereof. As will be appreciated by those of skill in the art, the above-listed flavors may be categorized as natural, artificial, natural WONF, natural type, natural and artificial and/or organic, depending on how derived and combined.

“Enhanced flavorings,” in accordance with the invention, comprise both a phytosterol and a flavoring. In one embodiment, powdered phytosterols are incorporated into the flavorings. Possible carriers or matrices in which phytosterols incorporate well are fats and sugars. Examples of specific carriers that may be used with the invention include, but are not limited to oils, maltodextrin, modified food starch, gum arabic, xanthan gum and combinations thereof. Enhanced flavorings may be provided as either oil-soluble or water-soluble liquids, powders or pastes.

The enhanced flavorings comprising phytosterols can be used to impart flavor in a wide variety of foods. “Enhanced foods,” in accordance with the invention, comprise foods incorporating enhanced flavorings. As will be understood, any food which can be flavored may be used in conjunction with the present invention to incorporate phytosterols in the diet. Examples of such foods include, but are not limited to, popcorn, baked goods, cheese sauce, dips, condiments, dressings, marinades, fillings, toppings, snack blends and side dishes, cereals, yogurt, fried foods, prepared meals, dairy products, frostings, gravies, ice cream, snacks and chips, crackers, puddings, candies and nutritional bars. As will be appreciated by those of skill in the art, nutritional bars may also be called “meal-replacement bars,” “energy bars,” “power bars,” “protein bars,” “cereal bars,” “diet bars,” “snack bars,” “fruit bars,” and/or “breakfast bars.” The term “foods,” as used herein, expressly does not include beverages. A “beverage” is a liquid product that is usually consumed for the purpose of quenching thirst, providing nutrition and/or for its alcoholic content.

Examples of foods in which enhanced butter flavorings may be used include, but are not limited to, popcorn, baked goods, sauces, salad dressings, nutrition bars, snack blends, fermented milk products and fried foods. Examples of foods in which enhanced cheese flavorings may be used include, but are not limited to, sauces, snacks, popcorn, salad dressings, and cheese spreads. Examples of foods in which enhanced vanilla flavorings may be used include, but are not limited to, sauces, puddings, ice cream, and baked goods. Examples of foods in which enhanced spice flavorings may be used include, but are not limited to, fried foods, popcorn, sauces, and salad dressings. Examples of foods in which enhanced meat flavorings may be used include, but are not limited to, gravies, sauces, and processed meats. Examples of foods in which enhanced fruit flavors may be used include, but are not limited to, candy, ice cream, and dairy products.

Examples of other suitable foods with which the enhanced flavorings may be used include, but are not limited to, baked goods, biscuit mixes, boxed dinners, breakfast (e.g., oatmeal and grits), brownie mixes, candy, cake mixes, canned biscuits, cheese spreads, coffee creamers, cookies (e.g., chocolate chip), croutons, dairy products, dips, dry mixes, flavored milks (e.g., chocolate or strawberry), french fries, fried foods, granola/cereal bars, the multitude of snack bars on the market, gravies, ice cream, icing for cakes and pastries, juices, mayonnaise, muffin mix, mustard, pasta sauce, pie filling, pizza rolls, ravioli, tortellini fillings, pizza products, popcorn, pop tarts (filling, icing, and crust), processed (mashed and formed) potato products, processed meats (e.g., hot dogs, sausage, hamburger, turkey loaf), processed cheese spreads, cheese analogs, cottage cheese, cream cheese, sour cream, puddings, ready to bake cookie dough, salad dressings, sauces, shortbread, snacks, soups, syrup, wafers, and yogurt.

It is possible, using the method of the invention, to incorporate sufficient amounts of enhanced flavorings such that health claims may then be made about these foods. More particularly, foods that have been flavored with the enhanced flavorings of the invention can be used to reduce blood cholesterol levels and reduce the risk of coronary heart disease.

Those having skill in the art will be able to readily ascertain the amount of phytosterol that should be incorporated into a particular flavoring, such that when the flavoring is used with a food, the food will comprise an effective amount of phytosterol. An “effective amount,” as used herein, refers to the amount of phytosterol per serving of food which is sufficient to support a health claim on the food's label in accordance with FDA regulations, for example, as described in 21 CFR 101.83, which is incorporated herein by reference in its entirety. Thus, it will be appreciated that the effective amount is dependent on the type of food, the serving size and the amount of flavoring to be incorporated into the food. Typically, however, the enhanced flavoring is added to the food such that it comprises about 0.1% -5.0% by weight of the finished food product.

Accordingly, a “serving,” as used herein, refers to the FDA Reference Amount Customarily Consumed per eating occasion, or “RACC,” which is calculated based on data set forth in national food consumption surveys. RACCs for specific foods consumed are found in 21 CFR 101.12, which is incorporated herein by reference in its entirety. Effective amounts of phytosterol per serving generally comprise at least about 200 mg, more preferably at least about 400 mg of free phytosterols. Typical effective amounts may include at least about 400 mg, and more preferably at least about 650 mg of phytosterol esters. Effective amounts of total phytosterols comprise at least about 200 mg, and more preferably, at least about 400 mg per serving. Other servings may comprise about 800 mg or less, and more preferably 650 mg or less, of total phytosterols per serving.

Verification of successful incorporation of effective amounts of phytosterols in particular foods in accordance with the present invention can be carried out, if necessary, to justify food product health claims. One suitable extraction procedure that can be used to extract phytosterols from popcorn and other food materials involves extracting sterols from the food matrix, followed by cleaning-up the extract by chemical or physical means. The extracted material is then concentrated and derivatized if necessary. Analysis of the extracts may then be conducted using standard methods known in the art, such as gas chromatography. High-performance liquid chromatography can also be used as appropriate. An internal standard is used for the analysis and results are compared to those of a known standard.

The following examples are provided to assist in a further understanding of the invention. The particular materials and conditions employed are intended to be further illustrative of the invention and are not limiting to the reasonable scope thereof.

### EXAMPLES

### Example 1

Phytosterol Blend

One specific phytosterol blend is commercially available as CHOLESTATIN® (Degussa Bioactives, Waukesha, Wis.). CHOLESTATIN® is a naturally occurring phytosterol complex derived from vegetable oil distillates, including primarily soybean oil. CHOLESTATIN® comprises, by weight, at least about 40.0% beta-sitosterol, at least about 20.0% campesterol, at least about 11.0% stigmasterol, and at least about 0.3% brassicasterol. The total sterol amount in the final blend is greater than about 85.0%. CHOLESTATIN® may also comprise up to 0.1% ash, and have a bulk density of approximately 0.6 grams per mL.

### Example 2

Microwave Popcorn

To produce an enhanced butter flavoring for use in microwave popcorn, the following ingredients were blended at ambient temperature until nearly uniform using a ribbon blender:

| Ingredient | Weight % |
|---|---|
| Natural/Artificial Butter Flavor | 31.03 |
| (Degussa Flavors, Cincinnati, OH, Product No. | |
| 086-03158) | |
| CHOLESTATIN ® (20 mesh) | 68.97 |

The enhanced butter flavoring was then added to microwave popcorn. More particularly, about 1.74 grams was added to each bag of microwave popcorn, containing three servings. This amount of enhanced flavoring provided each 30 gram serving of popcorn with an effective amount of phytosterols (i.e., at least 400 mg per serving) sufficient to make a health claim on the popcorn's product label.

### Example 3

Vanilla-Flavored Baked Goods

To produce an enhanced artificial sweet vanilla flavoring for use in baked goods, the following ingredients are blended at ambient temperature until uniform using conventional blending techniques:

| Ingredient | Weight % |
|---|---|
| Artificial sweet vanilla powder | 23.50 |
| (Degussa Flavors, Cincinnati, OH, Product No. | |
| 086-03300) | |
| CHOLESTATIN ® (20 mesh) | 59.00 |
| Maltodextrin | 17.5 |

The enhanced vanilla flavoring is used in cakes or muffins. More particularly, about 2.75 grams of the enhanced flavoring is added to a 97.25 gram cake or muffin mix comprising flour, sugar and salt. Assuming 55.0 grams would constitute a serving, each serving would comprise an effective amount of phytosterols (i.e., at least 400 mg per serving) sufficient to make a health claim on the product label.

### Example 4

Fruit-Flavored Baked Goods

To produce an enhanced blueberry flavoring for use in baked goods, the following ingredients are blended at ambient temperature until nearly uniform using a standard blender:

| Ingredient | Weight % |
|---|---|
| Natural artificial blueberry flavor powder | 40.89 |
| (Degussa Flavors, Cincinnati, OH, Product | |
| Number 086-03176) | |
| CHOLESTATIN ® (20 mesh) | 59.11 |

The enhanced blueberry flavoring is used in cakes or muffins. More particularly, about 2.0 grams of this blend is added to 98 grams cake or muffin mix comprising flour, sugar and salt. Assuming 40 grams would constitute a serving, each serving would comprise an effective amount of phytosterols (i.e., at least 400 mg per serving) sufficient to make a health claim on the product label.

### Example 5

Cheese Sauce Dry Mix

To produce an enhanced cheese flavoring for use in sauces, the following ingredients are blended at ambient temperature until nearly uniform using a standard blender:

| Ingredient | Weight % |
|---|---|
| Cheddar cheese powder | 55.00 |
| (Degussa Flavors, Cincinnati, OH, Product No. | |
| 086-03306) | |
| CHOLESTATIN ® (20 mesh) | 45.00 |

The enhanced cheese flavoring can be incorporated into a cheese sauce dry mix. More particularly, about 6.0 grams of this blend is used with 94.0 grams of cheese sauce dry mix. Assuming 15.0 grams mixed with one-half cup of water or milk would constitute a serving, each serving would comprise an effective amount of phytosterols (i.e., at least 400 mg per serving) sufficient to make a health claim on the product label.

### Example 6

Dressings

To produce an enhanced Italian flavoring for use in dressings, the following ingredients are blended at ambient temperature until nearly uniform using a standard blender:

| Ingredient | Weight % |
|---|---|
| Italian spice flavor powder | 60.00 |
| (Degussa Flavors, Cincinnati, OH, Product No. | |
| 086-03307) | |
| CHOLESTATIN ® (20 mesh) | 40.00 |

The enhanced Italian flavoring is then incorporated into salad dressings at approximately 3.3 percent by weight of final prepared dressing. This will yield 400 mg of phytosterols per 30 gram serving of dressing. Therefore, each serving would comprise an effective amount of phytosterols (i.e., at least 400 mg per serving) sufficient to make a health claim on the product label.

### Example 7

Nutrition Bars

To produce an enhanced artificial sweet vanilla flavoring for use in nutrition bars, the following ingredients are blended at ambient temperature until nearly uniform using a standard blender:

| Ingredient | Weight % |
|---|---|
| CHOLESTATIN ® (20 mesh) | 59.00 |
| Artificial sweet vanilla flavor powder | 23.5 |
| (Degussa Flavors, Cincinnati, OH, Product No. | |
| 086-03300) | |
| Maltodextrin | 17.5 |

This enhanced vanilla flavor may be used in nutrition bars at two percent by weight of the final nutrition bar. Each 40 gram serving would comprise an effective amount of phytosterols (i.e., at least 400 mg per serving) sufficient to make a health claim on the product label.

### Example 8

Snack Blends and Side Dishes

To produce an enhanced artificial salsa flavoring for use in snack blends and side dishes, the following ingredients are blended at ambient temperature until nearly uniform using a standard blender:

| Ingredient | Weight % |
|---|---|
| Artificial sweet salsa flavor | 46.67 |
| (Degussa Flavors, Cincinnati, OH, Product No. | |
| 086-03302) | |
| CHOLESTATIN ® (20 mesh) | 13.33 |
| Tomato | 40.00 |

This enhanced salsa flavor may be used in pastas or entrees at 3.3 percent by weight of the final ready-to-eat food. Each 30 gram serving would comprise an effective amount of phytosterols (i.e., at least 400 mg per serving) sufficient to make a health claim on the product label.

### Example 9

Fermented Milk Products—Yogurt

To produce a natural cherry flavor WONF water-soluble emulsion for use in dairy products, the following ingredients are mixed and homogenized to uniformity:

| Ingredient | Weight % |
|---|---|
| Natural cherry flavor WONF | 1.30 |
| (Degussa Flavors, Cincinnati, OH, Product No. | |
| 086-03301) | |
| CHOLESTATIN ® (20 mesh) | 10.0 |
| Citric acid | 0.5 |
| Sodium benzoate | 0.1 |
| Food starch-modified | 20.0 |
| Water | 68.1 |

This enhanced cherry flavor may be used in yogurts at 1.8 percent by weight of the final product. Each 225 gram serving of yogurt would comprise an effective amount of phytosterols (i.e., at least 400 mg per serving) sufficient to make a health claim on the product label.

### Example 10

Fried Foods

To produce an enhanced natural onion flavoring for use in fried foods, the following ingredients are blended at ambient temperature until nearly uniform using a standard blender:

| Ingredient | Weight % |
|---|---|
| Onion flavor | 0.84 |
| (Degussa Flavors, Cincinnati, OH, Product No. | |
| 086-03308) | |
| Onion powder | 8.33 |
| CHOLESTATIN ® (20 mesh) | 33.33 |
| Maltodextrin | 57.5 |

This enhanced onion flavor may be incorporated into the batter of french fries. More particularly, about 1.2 grams of enhanced onion flavoring is incorporated into 20.0 grams of french fry batter. Assuming that 85.0 grams would constitute a serving of french fries (unprepared), each serving would comprise an effective amount of phytosterols (i.e., at least 400 mg per serving) sufficient to make a health claim on the product label.

### Example 11

Example 11 is similar to Example 6, except cholestatin has been replaced with a liquid phytosterol ester from Cargill. The two are blended with salad dressings. The FDA required amount for phytosterol esters is 650 mg/RACC.

To produce an enhanced Italian flavoring for use in dressings, the following ingredients are blended at ambient temperature until nearly uniform using a standard blender:

| Ingredient | Weight % |
|---|---|
| Italian spice flavor powder | 35.00 |
| (Degussa Flavors, Cincinnati, OH, Product No. 086- | |
| 03307) | |
| Corowise ™ Phytosterol Esters SE-C100 (Cargill) | 65.00 |

The enhanced Italian flavoring is then incorporated into salad dressings at approximately 3.3 percent by weight of final prepared dressing. This will yield 650 mg of phytosterols per 30 gram serving of dressing. Therefore, each serving would comprise an effective amount of phytosterols (i.e., at least 650 mg per serving) sufficient to make a health claim on the product label.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

All publications, patents and patent applications referenced in this specification are indicative of the level of ordinary skill in the art to which this invention pertains. All publications, patents and patent applications are herein expressly incorporated by reference to the same extent as if each individual publication or patent application was specifically and individually indicated by reference. In case of conflict between the present disclosure and the incorporated patents, publications and references, the present disclosure should control.

The invention has been described with reference to various specific embodiments and techniques. However, it should be understood that many variations and modifications may be made while remaining within the spirit and scope of the invention.

1) A method of incorporating phytosterols into food comprising:
a) adding at least one phytosterol to at least one flavoring to provide an enhanced flavoring; and
b) adding the enhanced flavoring to a food to provide an enhanced food.

2) The method of claim 1, wherein at least a portion of the phytosterol is in powder, liquid or paste form.

3) The method of claim 1, wherein the flavoring comprises an artificial flavoring.

4) The method of claim 1, wherein the flavoring comprises a natural flavoring.

5) The method of claim 1, wherein the flavoring comprises an organic flavoring.

6) The method of claim 1, wherein the flavoring comprises a blend of natural and artificial flavorings.

7) The method of claim 1, wherein the flavoring comprises at least one of vanilla, chocolate, butter, cheese, strawberry, raspberry, blueberry, orange, lemon, apple, grape, lemon-lime, lime, watermelon, coconut, beef, bacon, chicken, pork, onion, garlic, pepper, ranch, nacho, taco, cheddar, romano, parmesan, cream, buttermilk and blue cheese, and combinations thereof.

8) The method of claim 1, wherein the phytosterol comprises at least one of plant-derived saturated or unsaturated sterol alcohols or blends thereof; synthetically produced sterol alcohols or blends thereof; and combinations thereof.

9) The method of claim 1, wherein the phytosterol comprises a free phytosterol.

10) The method of claim 9, wherein the phytosterol comprises at least one of α-sitosterol, β-sitosterol, ergosterol, stigmasterol, campesterol, brassicasterol, 22,23-dihydrobrassicasterol, α-sitostanol, β-sitostanol, stigmastanol, campestanol or 24β-methyl cholestanol and combinations thereof.

11) The method of claim 1, wherein the phytosterol comprises about 80% to about 90% by weight sterols.

12) The method of claim 11, wherein the phytosterol comprises about 85% by weight sterols.

13) The method of claim 1, wherein the phytosterol comprises a phytosterol complex comprising:
at least about 40% by weight β-sitosterol;
at least about 20% by weight campesterol;
at least about 11% by weight stigmasterol; and
at least about 0.3% by weight brassicasterol.

14) The method of claim 1, wherein the enhanced food comprises about 200 mg to about 800 mg phytosterol per serving of the enhanced food.

15) The method of claim 14, wherein the enhanced food comprises about 400 mg to about 650 mg phytosterol per serving of the enhanced food.

16) The method of claim 1, wherein the enhanced food comprises popcorn, sauces, gravies, salad dressings, ice cream, snacks, cheese spreads, puddings, baked goods, candies or dairy products.

17) The method of claim 1, wherein the flavoring comprises butter flavoring.

18) The method of claim 17, wherein the enhanced food comprises popcorn.

19) The method of claim 1, wherein the enhanced food comprises an effective amount of phytosterol per serving sufficient to make a health claim on a product label of the enhanced food.

20) The method of claim 1, wherein the enhanced flavoring comprises 0.1% -5.0% by weight of the enhanced food.

21) An enhanced flavoring composition comprising:
a) at least one phytosterol; and
b) at least one flavoring.

22) The enhanced flavoring composition of claim 19, wherein the flavoring comprises at least one of butter flavoring, vanilla flavoring, caramel flavoring, meat flavoring, fruit flavoring and combinations thereof.

23) The enhanced flavoring composition of claim 19, wherein the flavoring comprises butter flavoring.

24) The enhanced flavoring composition of claim 19, wherein the enhanced flavoring comprises an effective amount of phytosterols, the amount being effective to make a health claim on the product label of the enhanced food.
